(19) United States
(12) Patent Application Publication
(10) Pub. No.: US 2021/0091589 A1
(43) Pub. Date: Mar. 25, 2021

(54) CHARGING METHOD, CHARGING DEVICE AND READABLE STORAGE MEDIUM

(71) Applicant: BEIJING XIAOMI MOBILE SOFTWARE CO., LTD., Beijing (CN)

(72) Inventor: Jinlong ZHANG, Beijing (CN)

(73) Assignee: BEIJING XIAOMI MOBILE SOFTWARE CO., LTD., Beijing (CN)

(21) Appl. No.: 16/743,755

(22) Filed: Jan. 15, 2020

(30) Foreign Application Priority Data
Sep. 23, 2019 (CN) 201910901784.8

(51) Int. Cl. H02J 7/00

(52) U.S. Cl. CPC H02J 7/00714; H02J 7/007182; H02J 7/0048; H02J 7/005

(57) ABSTRACT

A charging method, a charging device and a readable storage medium are provided. The method includes: obtaining cell characteristic parameters of at least one cell contained in a battery; determining a charging strategy for the battery based on the cell characteristic parameters, different charging strategies corresponding to respective charging parameters; and charging the battery based on the charging strategy. Through the embodiments of the present disclosure, charging parameters may be flexibly adjusted in a charging process so as to improve the charging efficiency.

### CROSS-REFERENCE TO RELATED APPLICATION

This application is based upon and claims priority to Chinese Patent Application 201910901784.8, filed on Sep. 23, 2019, the disclosure of which is hereby incorporated by reference in its entirety.

### TECHNICAL FIELD

The present disclosure relates to the technical field of battery charging, and particularly relates to a charging method, a charging device and a readable storage medium.

### BACKGROUND

Electronic products on the market currently are provided with rechargeable batteries configured to charge electronic components in the electronic products, so that the electronic products may be continuously used and realize various functions. However, during charging of the batteries by a charging device, the batteries are usually charged only in accordance with a single charging mode, resulting in a problem that the charging efficiency is low or the aging rate of battery is fast.

### SUMMARY

The present disclosure provides a charging method, a charging device and a readable storage medium.

A first aspect according to the present disclosure provides a charging method, including: obtaining cell characteristic parameters of at least one cell contained in a battery; determining a charging strategy for the battery based on the cell characteristic parameters, different charging strategies corresponding to respective charging parameters; and charging the battery based on the charging strategy.

A second aspect according to the present disclosure provides a charging device, including: a first obtaining module, configured to obtain cell characteristic parameters of at least one cell contained in a battery; a second obtaining module, configured to determine a charging strategy for the battery based on the cell characteristic parameters, different charging strategies corresponding to respective charging parameters; and a charging module, configured to charge the battery based on the charging strategy.

A third aspect according to the present disclosure provides a charging device, including: a processor and a memory configured to store executable instructions capable of running on the processor, where when the executable instructions are running on the processor, the executable instructions execute any one of the operations in the charging method as described above.

A fourth aspect according to the present disclosure provides a non-transitory computer readable storage medium having stored therein computer-executable instructions that, when being executed by a processor, implement any one of the operations in the charging method as described above.

It should be understood that the above general description and the following detailed description are merely exemplary and explanatory, and not intended to limit the present disclosure.

### BRIEF DESCRIPTION OF THE DRAWINGS

The accompanying drawings, which are incorporated in and constitute a part of this specification, illustrate embodiments consistent with the disclosure and serve to explain the principles of the disclosure together with the description.

FIG. 1 is a flowchart of a charging method according to an example.

FIG. 2 is a schematic diagram of mapping between the number of times of charging cycles and a battery residual capacity ratio according to an example.

FIG. 3 is a schematic diagram of required charging duration when adopting a charging strategy according to an example.

FIG. 4 is a schematic diagram of step charge according to an example.

FIG. 5 is a schematic diagram of charging a battery upon adoption of a charging strategy according to an example.

FIG. 6 is a structural schematic diagram of a charging device according to an example.

FIG. 7 is a structural diagram of a terminal device according to an example.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the embodiments of the present disclosure. Instead, they are merely examples of apparatuses consistent with aspects related to the embodiments of the present disclosure as recited in the appended claims.

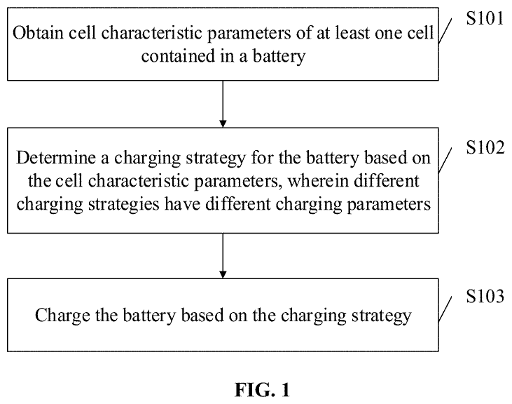

An embodiment of the present disclosure provides a charging method. FIG. 1 is a flowchart of a charging method according to an example. As shown in FIG. 1, the charging method is applied to a charging device and includes the following operations.

In S101, cell characteristic parameters of at least one cell contained in a battery are obtained.

In S102, a charging strategy of the battery is determined based on the cell characteristic parameters. Different charging strategies correspond to respective charging parameters.

In S103, the battery is charged based on the determined charging strategy.

In the embodiments of the present disclosure, the charging device is configured to charge the battery, and the battery is a rechargeable battery.

Exemplarily, the charging device includes, but not limited to, charging devices for mobile terminals such as mobile phone, vehicle charging device, and charging devices for various household electrical appliances. The battery includes, but is not limited to, a lithium battery, a nickel-cadmium (NiCd) battery, a nickel-hydrogen (NiH2) battery, and a lead-acid battery.

In the embodiments of the present disclosure, the battery includes at least one cell and a processing circuit. The cell is configured to store electric energy, and the processing circuit is configured to protect the cell or manage the electric energy stored in the cell. The cell characteristic parameters of each cell of the battery may be obtained through the processing circuit, and may accurately reflect the State of Charge (SOC) in the cell.

In examples, the cell characteristic parameters include, but not limited to, voltage of cell, current of cell, temperature of cell, directive current resistance (DCR) of cell, alternative current resistance (ACR) of cell and the number of times of charging cycles for which the cell has been charged, which are not limited in the embodiments of the present disclosure.

It should be noted that the battery may include one or more cells. When the battery includes one cell, the charging strategy of the battery may be directly determined according to respective cell characteristic parameters. When the battery includes a plurality of cells, if the plurality of cells are the same, the cell characteristic parameters corresponding to each of the plurality of same cells may be averaged, and the charging strategy of the battery is determined based on the averaged cell characteristic parameters; and if the plurality of cells are different, the cell characteristic parameters corresponding to each of the plurality of different cells may be weighted and averaged to determine the cell characteristic parameters of the different cells. As a result, the corresponding charging strategy is determined. In the process of weighting and averaging of the cell characteristic parameters for different cells, each weight value corresponding to a respective cell is related to capacity of the cell, and the weight value of the corresponding cell may be set according to different cell capacities. For example, if the capacity of a cell is large, the corresponding weight for the weighting average calculation should be large.

In the embodiments of the present disclosure, the battery involves different charging modes in a charging process, and different charging modes require different charging parameters. For example, when the charging mode is a constant voltage (CC) or constant current (CV) charging mode, charging parameters, such as cut-off charging current and cut-off charging voltage, are used to adjust different charging modes; and when the charging mode is a cycle charging mode, charging parameters, such as the health state, cycle charging voltage and cycle charging current of the battery, are used to adjust different charging modes. Therefore, charging parameters required for different charging modes are different.

It should be noted that when the charge strategy of the battery is determined, the charging strategy may include a charging mode, cell characteristic parameters corresponding to the charging mode, and charging parameters corresponding to the charging mode. For example, in a charging process, the charging device may firstly determine that the battery is in a CC/CV mode, and then determine the cut-off charging current and the cut-off charging voltage based on the cell characteristic parameters in a CC/CV charging mode.

In the embodiments of the present disclosure, after the charging strategy is determined, the battery is charged based on the charging strategy of the battery. If the charging strategy is that the charging parameters are determined to be the cut-off charging current and the cut-off charging voltage in a CC/CV mode, the battery may be charged according to the cut-off charging current and the cut-off charging voltage. If the charging strategy is that the charging parameters are determined to be a charging voltage of next charging cycle and a charging current of next charging cycle under a cycle charging mode, the cycle charge may be performed according to the charging voltage of next charging cycle and the charging current of next charging cycle.

It can be understood that in the embodiments of the present disclosure, the charging strategy may be flexibly determined according to the cell characteristic parameters which are changeable in a charging process, and the battery may be charged based on respective charging parameters corresponding to each of the different charging strategies, so that the charging mode is flexible and the charging efficiency is improved.

In an embodiment, the operation of determining the charging strategy for the battery based on the cell characteristic parameters includes:

determining the health state of the cell based on the DCR of the cell, the ACR of the cell and the number of times of charging cycles for which the cell has been charged;

and

determining the charging current and charging voltage of the battery based on the health state of the cell.

In the embodiments of the present disclosure, the cycle charging mode of the battery is that when the charge of the battery is at a preset charge value, the battery is charged automatically and cyclically. In the cycle charging mode, the number of times of charging cycles for the battery may directly reflect degradation degree of the battery; and in the cycle charging mode, the DCR and the ACR of the cell in the battery will increase with the number of times of charging cycles. At this time, compared with a battery with a small number of times of charging cycles, charging duration of a battery with a large number of times of charging cycles is prolonged and the rechargeable capacity of the battery is reduced. Therefore, the DCR of the cell, the ACR of the cell and the number of times of charging cycles for which the cell has been charged may reflect the present health state of the cell.

The health state of cell in the battery is different for different using states of the battery. Furthermore, the charging duration and charging capacity for the battery are different in different health states of cell. For a battery with a good health state of cell, its corresponding DCR and ACR of the cell are smaller, the charging duration is shorter, and the rechargeable capacity of the battery is larger. For a battery with a poor health state of cell, its corresponding DCR and ACR of the cell are larger. Therefore, during charging of the battery with a poor health state of cell, the charging current and/or the charging voltage may be appropriately reduced, so that consumption of the electric energy by the cell is reduced to improve the charging efficiency.

It should be noted that with the increase of the number of times of charging cycles, the cell DC impedance and cell AC impedance of the battery are increased and the rechargeable capacity of the battery is reduced, so that the charging voltage and charging current required for cyclically charging of the battery are also reduced. If the battery is charged by adopting the previous charging voltage and charging current in a charging process, the charging efficiency may not be improved, and the battery may be in an overcharged state for a long time, which affects the service life of the battery. Therefore, in the embodiments of the present disclosure, after the health state of the cell is determined, the charging current and charging voltage for the next charge are flexibly adjusted according to different health states of cells.

That is, in the embodiments of the present disclosure, when the battery is cyclically charged, the battery is not cyclically charged directly according to a constant charging current and a constant charging voltage, but the charging current and the charging voltage are adjusted immediately according to different health states of the battery, and the battery is charged based on the adjusted charging voltage and charging current. In this way, determination of different respective charging parameters according to each charging strategy enables the battery to adapt to charging requirements that may change in different cycle stages, thereby prolonging the service life of the battery.

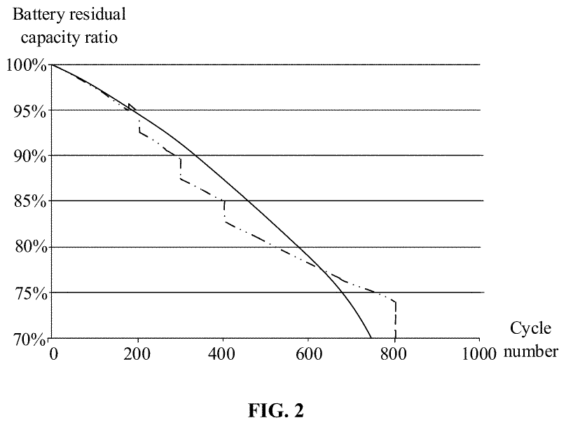

As shown in FIG. 2, a dotted line represents the mapping relationship between the number of times of charging cycles and battery residual capacity ratio upon charging of the battery by adopting a charging strategy in the embodiments of the present disclosure; and a solid line represents the mapping relationship between the number of times of charging cycles and battery residual capacity ratio upon charging of the battery without adopting a charging strategy. It can be seen from FIG. 2 that when the number of charging cycles for the battery is greater than 600 times, the battery residual capacity ratio when adopting the charge strategy is significantly higher than the battery residual capacity ratio without adopting the charging strategy. Visibly, in a cycle charging mode, the battery is charged by adopting the charging strategy provided in the embodiments of the present disclosure, that is, the charging current and charging voltage for next charging cycle are reasonably determined based on the health state of the battery to enable the charging current and the charging voltage to meet the need of the present rechargeable capacity of the battery, so that the cases of charging the battery for a long time by high voltage and heavy current is reduced, and thus degradation of the battery is delayed and the speed at which the battery residual capacity ratio decreases is slowed, thereby prolonging the service life of the battery.

In one or more embodiments, the operation of determining the charging strategy for the battery based on the cell characteristic parameters includes:

determining the cut-off charging voltage value of the battery under constant current charging mode according to the present voltage value of the cell, the present current of the cell and the present temperature of the cell; and

the operation of charging the battery based on the charging strategy includes:

charging the battery at a charging voltage value less than the cut-off charging voltage value and a constant charging current value under the constant current charging mode.

In one or more embodiments, the operation of determining the charging strategy for the battery based on the cell characteristic parameters includes:

determining the cut-off charging current value of the battery under the constant voltage charging mode according to the present voltage of the cell, the present current of the cell and the present temperature of the cell; and

the operation of charging the battery based on the charging strategy includes:

charging the battery at a charging current greater than the cut-off charging current value and a constant charging voltage under the constant voltage charging mode.

In the embodiments of the present disclosure, in a constant current charging mode, the charging current of the battery is constant, and the charging voltage of the battery is gradually increased; and when the charging voltage of the battery reaches the cut-off charging voltage value, the constant current charging mode is stopped and converted into a constant voltage charging mode for subsequent charging of the battery. In a constant voltage charging mode, the charging voltage of the battery is constant, and the charging current of the battery is gradually decreased; and when the charging current of the battery is decreased to the cut-off charging current value, the constant voltage charging mode is stopped.

Because the corresponding cell voltage, cell current and cell temperature of the battery at different times in a charging process are different, the cut-off charging voltage value and cut-off charging current value required at different charging durations are also different. Furthermore, the environment in which the battery is located also affects the charging voltage and charging current required for the battery. For example, the cell temperature is lower in a low-temperature environment. At this time, the charging voltage and charging current for the battery are lower than the charging voltage and charging current for the battery in a normal temperature state. As can be seen, the change of the environment temperature also causes the change of the charging voltage and the charging current, resulting in change of the cut-off charging voltage value and the cut-off charging current value.

Based on the above, the embodiments of the present disclosure fully consider the parameters that affect settings of the cut-off charging voltage value and the cut-off charging current value, and propose a solution of determining the cut-off charging voltage value and the cut-off charging current value of the battery under CC/CV charging mode based on three cell characteristic parameters, including the present voltage of the cell, the present current of the cell and the present temperature of the cell.

That is, in the embodiments of the present disclosure, in a charging process, constant current charge and constant voltage charge are performed according to the adjusted cut-off charging voltage value and cut-off charging current value, so that the charging parameters may be flexibly adjusted in the charging process to improve the charging efficiency.

It can be understood that in a charging process, the constant current charging duration is very short relative to the constant voltage charging duration; and in a constant voltage charging process, the charging current is gradually decreased, and until it is decreased to the cut-off charge current value, the constant voltage charging mode is ended. Therefore, the constant voltage charging duration may be shortened by increasing the cut-off charging current value, thereby shortening the charging duration of the entire CC/CV charging mode and improving the charging efficiency.

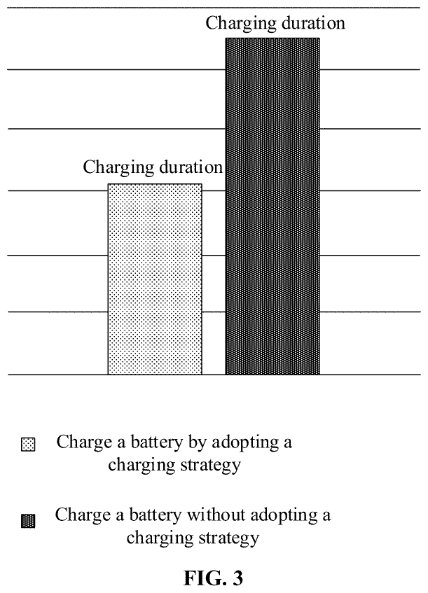

As shown in FIG. 3, a light-colored histogram represents the charging duration required for charging a battery of which the battery capacity is 4000 mAH by adopting a charging strategy in a CC/CV charging mode according to an embodiment of the present disclosure; and a dark histogram represents the charging duration required for charging the battery without adopting a charging strategy. As can be seen from FIG. 3, the charging duration for charging the battery by adopting the charging strategy according to an embodiment of the present disclosure is much less than the charging duration for charging the battery without adopting the charging strategy. After verification, compared with the charging duration for charging the battery without adopting the charging strategy, the charging duration for charging the battery by adopting the charging strategy according to an embodiment of the present disclosure may be shortened by 45%, and the charging efficiency may be greatly improved.

In an embodiment, the method also includes:

detecting the current charging state of the battery during charging of the battery;

when the charging state of the battery is a float charging state, suspending charging of the battery to release the float charging state;

and/or

when the charging state of the battery is a float charging state, perform control to accelerate discharging the battery to release the float charging state.

In the embodiments of the present disclosure, the float charging mode is a charging mode which is generated after the battery is charged to a certain stage. The float charging mode is characterized in that after a CC/CV charging mode, the battery is continuously charged with a current lower than a preset current threshold for a long time to enable the battery to be charged in the float charging mode. At this time, the charging state of the battery is a float charging state in the float charging mode. The preset current threshold may be set according to actual demands. For example, the preset current threshold may be 0.3 mA, 0.5 mA or 0.7 mA.

It should be noted that the operation of suspending charging of the battery includes that charging of the battery is no longer continued. The operation of releasing the float charging state of the battery means that the charging state of the battery in the float charging state is no longer the float charging state.

Considering that there are safety risks such as battery swelling and battery leakage because the battery is in a float charging state for a long time, it is necessary to detect the present charging state of the battery to facilitate the subsequent timely processing of the battery in the float charging state to release the float charging state, so as to reduce occurrence of the safety risks during charging of the battery.

In an embodiment, the operation of detecting the current charging state of the battery includes:

obtaining the SOC of the battery; and

when the duration for which the SOC of the battery is greater than a first SOC threshold reaches a preset length of time, determining that the battery is in a float charging state.

In the embodiments of the present disclosure, the SOC of the battery reflects the ratio or percentage that the battery residual capacity occupies the battery total capacity. When the SOC of the battery is 1, it indicates that the battery is in a full charge state. When the SOC of the battery is 0, it indicates that the battery is in a full discharging state. An upper threshold, namely a first SOC threshold of float charging of the battery in a float charging state may be set according to the rechargeable capacity of the battery. For example, when the rechargeable capacity of the battery is 98%, the first SOC threshold may be set to be 93% or 95%, which is not limited in the embodiments of the present disclosure.

It should be noted that the SOC of the battery is greater than the first SOC threshold in a float charging state, and therefore, the SOC of the battery may be reduced by suspending charging of the battery or accelerating discharging the battery so as to release the float charging state. It should be noted that the operation of accelerating discharging the battery may be enabling the battery to be in a working state actively. For example, when the battery is a battery of a mobile phone, accelerating of discharging the battery may be implemented by supplying power to components on the mobile phone through the battery.

In some embodiments, the method also includes:

when the SOC of the battery is less than a second SOC threshold, determining that the float charging state of the battery is released, where the second SOC threshold is less than the first SOC threshold.

In the embodiments of the present disclosure, the second SOC threshold may be set according to actual design requirements, so that the second SOC threshold is less than the first SOC threshold. For example, when the first SOC threshold is 95%, the second SOC threshold may be set to be 90%; and when the first SOC threshold is 93%, the second SOC threshold may be set to be 89%.

It should be noted that by setting the second SOC threshold to be less than the first SOC threshold, the battery may not be frequently switched between release of a float charging state and being in a float charging state, so that the battery is smoothly charged to reduce the influence on the battery caused by frequently switching between charging states.

It can be understood that in the embodiments of the present disclosure, when the battery is in a float charging state, the float charge state of the battery is released by suspending charging of the battery or accelerating discharging the battery, which enables to reduce safety risks, such as battery swelling and battery bulging, caused by charging of the battery at a current lower than a preset current threshold under a continuous voltage, thereby achieving protection of the charging safety during charging of the battery.

After the float charging state of the battery is released, the charging of the battery may be restored or the accelerating discharging the battery may be stopped, so as to increase the SOC of the battery. It should be noted that the operation of restoring the charging of the battery may be as follows: after the float charging state of the battery is released, the cell characteristic parameters of each cell involved in the battery are obtained continuously, the charging strategy for the battery is determined based on the cell characteristic parameters, and the battery is charged based on the charging strategy. For example, after the float charging state of the battery is released, the battery is in a cycle charging mode, and at this time, the operation of charging the battery based on the charging strategy includes: determining the present charging current and present charging voltage of the battery based on the health state of the cell so as to charge the battery based on the determined present charging voltage and present charging current.

In related technologies, different charging currents are set according to battery temperatures to charge the battery. The following table 1 shows charging modes at different temperatures, wherein CC represents constant current charging mode, CV represents constant voltage charging mode, 0.1 C represents charging current, and “CC 0.1 C to 4.4V, then CV to 200 mA” means that under the constant current charging mode, the battery is charged at a constant current 0.1 C as a charging current until the voltage of the battery is 4.4V, and then, under the constant voltage charging mode, the battery is charged at a constant voltage until the current of the battery is 200 mA.

As illustrated in table 1, the charging mode is determined based on its corresponding temperature of the battery, which is only applied to charging of the battery in the constant current and constant voltage charging mode. The determination basis is single, and the charging efficiency for the battery is low.

TABLE 1

| Temperature | Charging mode |
|---|---|
| 0 to 5° C. | CC 0.1 C to 4.4 V, then CV to 200 mA |
| 5° C. to 10° C. | CC 0.3 C to 4.4 V, then CV to 200 mA |
| 10° C. to 15° C. | CC 0.5 C to 4.4 V, then CV to 200 mA |
| 15° C. to 45° C. | CC 1.0 C to 4.4 V, then CV to 200 mA |
| 45° C. to 60° C. | CC 0.5 C to 4.1 V, then CV to 200 mA |

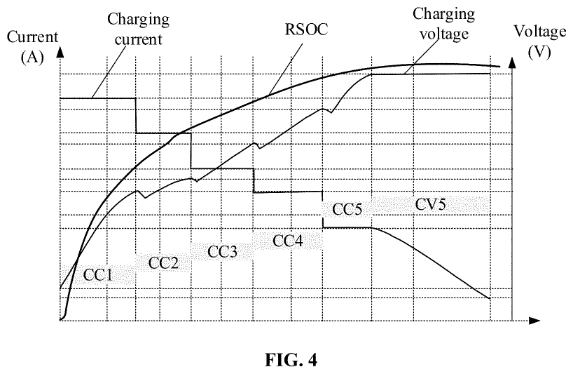

As shown in FIG. 4, FIG. 4 shows set of different multi-step charge according to battery temperature, battery current and battery voltage, where CC is constant current charge, and CV is constant voltage charge. As can be seen from FIG. 4, in a charging process, the CC charge is performed 5 times; and in a step charge process at a high voltage in a constant current charging mode, the charging current has a step decrease trend with the charging process, the charging voltage has an increase trend with the charging process, and the ratio of SOC (RSOC) gradually increases with the charging process. Due to there is a sudden decrease between the constant current at two ends, the speed for charging the battery is affected, and the service life of the battery is also affected because of such long-time sudden decrease.

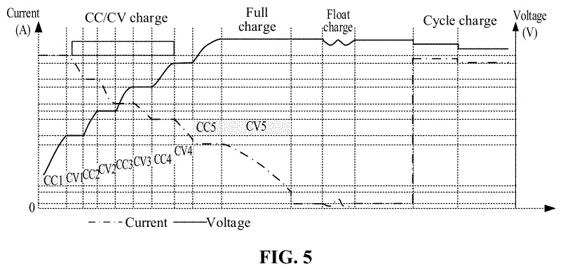

As shown in FIG. 5, FIG. 5 shows a schematic diagram of charging a battery by adopting a charging method provided by embodiments of the present disclosure, where CC is constant current charge, and CV is constant voltage charge. As can be seen from FIG. 5 that the battery is sequentially charged for 5 times in CC/CV charge according to the adjusted cut-off charging voltage value and cut-off charging current value. The current does not suddenly decrease in different constant current charging modes, but decreases slowly until the battery is in a full charge state.

After the full charge state, the battery is in a float charge state, and the float charge state is released by accelerating discharge. According to a voltage fluctuation curve and a current fluctuation curve for charging, as shown in FIG. 5, the float charging duration may be effectively reduced, and battery safety risks, such as battery swelling and battery bulging, caused by charging of the battery with continuous constant voltage and small current may be reduced.

In a cycle charge mode, firstly, the health state of each cell is determined based on the DCR of the cell, the ACR of the cell and the number of times of charging cycles for which the cell has been charged; then, the charging current and charging voltage of the battery are determined based on the health state of the cell; and the battery is charged based on the determined charging current and charging voltage, so that the charging current and the charging voltage may be adjusted to prolong the service life of the battery. With the increase of the number of times of charging cycles, degradation of the battery occurs, and the DCR and ACR of the battery are increased, so that the charging current and charging voltage required for the battery are gradually decreased. As shown in FIG. 5, the charging voltage and charging current adopted in previous charging cycle are higher than the charging voltage and charging current adopted in the next charging cycle.

It should be noted that the terms “first”, “second”, “third” and “fourth” in the above embodiments of the present disclosure are merely convenient for expression and distinction, and have no other specific meanings.

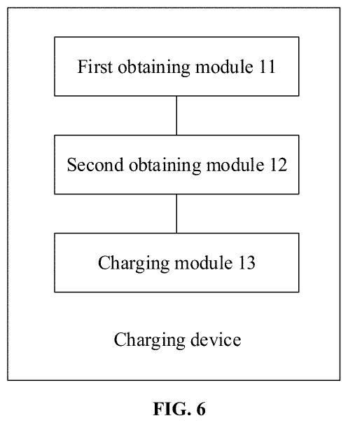

An embodiment of the present disclosure also provides a charging device. As shown in FIG. 6, a device 10 includes:

a first obtaining module 11 configured to obtain cell characteristic parameters of at least one cell contained in a battery;

a second obtaining module 12 configured to determine a charging strategy for the battery based on the cell characteristic parameters, different charging strategies corresponding to respective charging parameters; and

a charging module 13 configured to charge the battery based on the charging strategy.

In an embodiment, the second obtaining module 12 is configured to determine, in a cycle charging mode, the health state of the cell based on the DCR of the cell, the ACR of the cell and the number of times of charging cycles for which the cell has been charged, and determine the charging current and charging voltage of the battery based on the health state of the cell.

In an embodiment, the second obtaining module 12 is configured to determine, in a CV/CC charging mode, the cut-off charging voltage value of the battery under constant current charging mode according to the present voltage of the cell, the present current of the cell and the present temperature of the cell; and

the charging module 13 is configured to charge the battery at a charging voltage less than the cut-off charging voltage value and a constant charging current under constant current charging mode.

In an embodiment, the second obtaining module 12 is configured to determine, in a CV/CC charging mode, the cut-off charging current value of the battery under constant voltage charging mode according to the present voltage of the cell, the present current of the cell and the present temperature of the cell; and

the charging module 13 is configured to charge the battery at a charging current greater than the cut-off charging current value and a constant charging voltage under constant voltage charging mode.

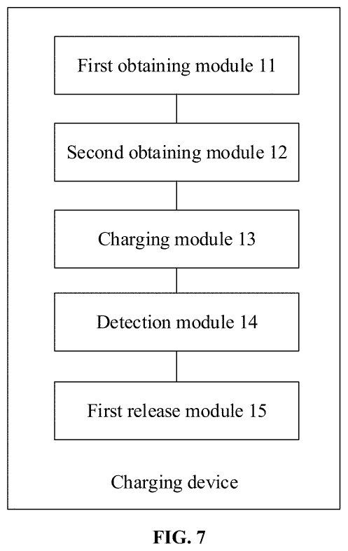

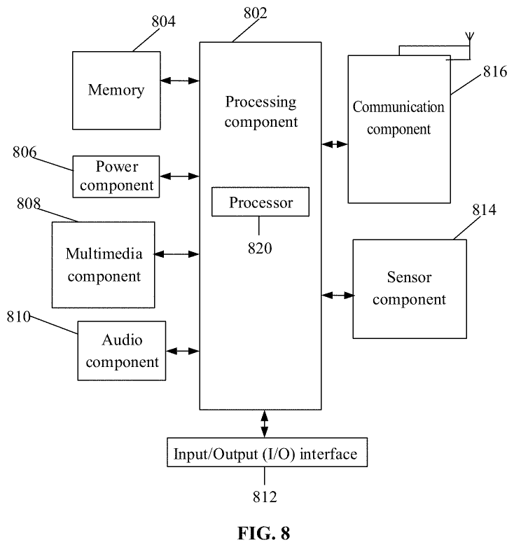

In an embodiment, as shown in FIG. 7, the device also includes:

a detection module 14 configured to detect the current charging state of the battery during charging of the battery; and

a first release module 15 configured to suspend charging of the battery to release the float charging state when the charging state of the battery is a float charging state, and/or perform control to accelerate discharging the battery to release the float charging state when the charging state of the battery is a float charging state.

In an embodiment, the detection module 14 is specifically configured to obtain the SOC of the battery, and determine that the battery is in a float charging state when the duration for which the SOC of the battery is greater than a first SOC threshold reaches a preset length of time period.

In an embodiment, the charging device also includes:

a second release module configured to determine that the float charging state of the battery is released when the SOC of the battery is less than a second SOC threshold, where the second SOC threshold is less than the first SOC threshold.

FIG. 8 is a structure diagram of a terminal device according to an example.

For example, a terminal device 800 may be a mobile phone, a computer, a digital broadcast terminal, a message receiving and sending device, a game console, a tablet device, a medical device, a fitness device, a personal digital assistant, and the like. Referring to FIG. 8, the terminal device 800 may include one or more of the following components: a processing component 802, a memory 804, a power component 806, a multimedia component 808, an audio component 810, an Input/Output (I/O) interface 812, a sensor component 814 and a communication component 816.

The processing component 802 usually controls the overall operations of the terminal device 800, such as operations related to display, telephone calls, data communications, camera operations and recording operations. The processing component 802 may include one or more processors 820 to execute instructions to perform all or part of the above method. Furthermore, the processing component 802 may include one or more modules which facilitate interaction between the processing component 802 and other components. For example, the processing component 802 may include a multimedia module to facilitate interaction between the multimedia component 808 and the processing component 802.

The memory 804 is configured to store various types of data to support operations of the terminal device 800. The examples of the data include instructions for any application programs or methods operated on the terminal device 800, contact data, phone book data, messages, pictures, videos, and the like. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 supplies power to various components of the terminal device 800. The power component 806 may include a power management system, one or more power supplies, and other components associated with generation, management and distribution of power for the terminal device 800.

The multimedia component 808 includes a screen providing an output interface between the terminal device 800 and a user. In some embodiments, the screen may include a Liquid Crystal Display (LCD) and a Touch Panel (TP). If the screen includes the TP, the screen may be implemented as a touch screen to receive input signals from users. The TP includes one or more touch sensors to sense touches, slides and gestures on the TP. The touch sensor may not only sense the boundary of the touch or slide operation, but also detect the duration and pressure related to the touch or slide operation. In some embodiments, the multimedia component 808 includes a front camera and/or a rear camera. When the terminal device 800 is in an operation mode, such as a shooting mode or a video mode, the front camera and/or the rear camera may receive external multimedia data. Each of the front camera and the rear camera may be a fixed optical lens system or have focal length and optical zoom capabilities.

The audio component 810 is configured to output and/or input audio signals. For example, the audio component 810 includes a microphone (MIC), and the MIC is configured to receive external audio signals when the terminal device 800 is in an operation mode, such as a call mode, a recording mode and a voice recognition mode. The received audio signals may be further stored in the memory 804 or sent through the communication component 816. In some embodiments, the audio component 810 also includes a loudspeaker configured to output audio signals.

The I/O interface 812 provides an interface between the processing component 802 and a peripheral interface module, and the peripheral interface module may be a keyboard, a click wheel, a button, and the like. These buttons may include, but are not limited to, a Home button, a Volume button, a Start button and a Lock button.

The sensor component 814 includes one or more sensors configured to provide state evaluation of various aspects to the terminal device 800. For example, the sensor component 814 may detect an on/off status of the terminal device 800 and the relative positioning of the components such as a display and a keypad of the terminal device 800, and the sensor component 814 may also detect a change in a position of the terminal device 800 or a component of the terminal device 800, the presence or absence of contact between a user and the terminal device 800, the orientation or acceleration/deceleration of the terminal device 800, and the temperature change of the terminal device 800. The sensor component 814 may include a proximity sensor configured to detect the presence of nearby objects without any physical contact. The sensor component 814 may also include an optical sensor, such as a CMOS or CCD image sensor for use in imaging applications. In some embodiments, the sensor component 814 may also include an acceleration sensor, a gyro sensor, a magnetic sensor, a pressure sensor or a temperature sensor.

The communication component 816 is configured to facilitate wired or wireless communication between the terminal device 800 and other devices. The terminal device 800 may access a communication-standard-based wireless network, such as a Wireless Fidelity (Wi-Fi) network, a 2nd-Generation (2G) or 3rd-Generation (3G) network, or a combination thereof. In an example, the communication component 816 receives broadcast signals or broadcast related information from an external broadcast management system through a broadcast channel. In an example, the communication component 816 also includes a Near Field Communication (NFC) module to promote short range communication. For example, the NFC module may be implemented based on a Radio Frequency Identification (RFID) technology, an Infrared Data Association (IrDA) technology, an Ultra Wide Band (UWB) technology, a Bluetooth (BT) technology and other technologies.

In an example, the terminal device 800 may be implemented by one or more of an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor or other electronic components, and configured to execute the above method.

In an example, the present disclosure also provides a non-transitory computer readable storage medium including instructions, such as the memory 804 including instructions, and the instructions may be executed by the processor 820 of the terminal device 800 to complete the above charging method. For example, the non-transitory computer readable storage medium may be a Read-Only Memory (ROM), a Random Access Memory (RAM), a Compact Disc Read-Only Memory (CD-ROM), a magnetic tape, a floppy disk, an optical data storage device, and the like.

When an instruction in a non-transitory computer readable storage medium is executed by a processor of a mobile terminal, the mobile terminal may execute a charging method. The method may include the following operations:

obtaining cell characteristic parameters of at least one cell contained in a battery;

determining a charging strategy for the battery based on the cell characteristic parameters, wherein different charging strategies correspond to respective charging parameters; and

charging the battery based on the charging strategy.

Other embodiments of the disclosure will be apparent to those skilled in the art from consideration of the specification and practice of the disclosure here. This application is intended to cover any variations, uses, or adaptations of the disclosure following the general principles thereof and including such departures from the disclosure as come within known or customary practice in the art. It is intended that the specification and embodiments be considered as exemplary only, with a true scope and spirit of the disclosure being indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A charging method, comprising:
obtaining cell characteristic parameters of at least one cell contained in a battery;
determining a charging strategy for the battery based on the cell characteristic parameters, wherein different charging strategies correspond to respective charging parameters; and
charging the battery based on the charging strategy.

2. The method of claim 1, wherein determining the charging strategy for the battery based on the cell characteristic parameters comprises:
determining, under a cycle charging mode, a health state of each cell based on a directive current resistance (DCR) of the cell, an alternative current resistance (ACR) of the cell and a number of times of charging cycles for which the cell has been charged; and
determining a charging current and a charging voltage of the battery based on the health state of the cell.

3. The method of claim 1, wherein determining the charging strategy for the battery based on the cell characteristic parameters comprises:
determining a cut-off charging voltage of the battery under a constant current charging mode according to a present voltage of the cell, a present current of the cell and a present temperature of the cell; and
wherein charging the battery based on the charging strategy comprises:
charging the battery at a charging voltage less than the cut-off charging voltage and a constant charging current under the constant current charging mode.

4. The method of claim 1, wherein determining the charging strategy for the battery based on the cell characteristic parameters comprises:
determining a cut-off charging current of the battery under a constant voltage charging mode according to a present voltage of the cell, a present current of the cell and a present temperature of the cell; and
wherein charging the battery based on the charging strategy comprises:
charging the battery at a charging current greater than the cut-off charging current and a constant charging voltage under the constant voltage charging mode.

5. The method of claim 1, further comprising:
detecting a present charging state of the battery during charging of the battery;
when the present charging state of the battery is a float charging state, suspending charging of the battery to release the float charging state; and/or
when the present charging state of the battery is the float charging state, controlling the battery to accelerate discharging to release the float charging state.

6. The method of claim 5, wherein detecting the present charging state of the battery comprises:
obtaining a state of charge (SOC) of the battery; and
when a duration for which the SOC of the battery is greater than a first SOC threshold reaches a preset length of time, determining that the battery is in the float charging state.

7. The method of claim 6, further comprising:
when the SOC of the battery is less than a second SOC threshold, determining that the float charging state of the battery is released, wherein the second SOC threshold is less than the first SOC threshold.

8. A charging device, comprising:
a processor; and
a memory for storing instructions executed by the processor,
wherein the processor is configured to:
obtain cell characteristic parameters of at least one cell contained in a battery;
determine a charging strategy for the battery based on the cell characteristic parameters, wherein different charging strategies correspond to respective charging parameters; and
charge the battery based on the charging strategy.

9. The device of claim 8, wherein the processor is configured to determine, under a cycle charging mode, a health state of each cell based on a directive current resistance (DCR) of the cell, an alternative current resistance (ACR) of the cell and a number of times of charging cycles for which the cell has been charged; and determine a charging current and a charging voltage of the battery based on the health state of the cell.

10. The device of claim 9, wherein the processor is configured to:
determine a cut-off charging voltage of the battery under a constant current charging mode according to a present voltage of the cell, a present current of the cell and a present temperature of the cell; and
charge the battery at a charging voltage less than the cut-off charging voltage and a constant charging current under the constant current charging mode.

11. The device of claim 9, wherein the processor is configured to:
determine a cut-off charging current of the battery under a constant voltage charging mode according to a present voltage of the cell, a present current of the cell and a present temperature of the cell; and
charge the battery at a charging current greater than the cut-off charging current and a constant charging voltage under the constant voltage charging mode.

12. The device of claim 8, wherein the processor is further configured to:
detect a present charging state of the battery during charging of the battery;
suspend charging of the battery to release a float charging state when the present charging state of the battery is the float charging state; and, control the battery to accelerate discharging to release the float charging state when the charging state of the battery is a float charging state.

13. The device of claim 12, wherein the processor is configured to:
obtain a state of charge (SOC) of the battery; and
determine that the battery is in the float charging state when a duration for which the SOC of the battery is greater than a first SOC threshold reaches a preset length of time.

14. The device of claim 13, wherein the processor is further configured to:
determine that the float charging state of the battery is released when the SOC of the battery is less than a second SOC threshold, wherein the second SOC threshold is less than the first SOC threshold.

15. A non-transitory computer readable storage medium having stored therein computer-executable instructions that, when being executed by a processor, cause the processor to perform acts comprising:
obtaining cell characteristic parameters of at least one cell contained in a battery;
determining a charging strategy for the battery based on the cell characteristic parameters, wherein different charging strategies correspond to respective charging parameters; and
charging the battery based on the charging strategy.

16. The non-transitory computer readable storage medium of claim 15, wherein determining the charging strategy for the battery based on the cell characteristic parameters comprises:
determining, under a cycle charging mode, a health state of each cell based on a directive current resistance (DCR) of the cell, an alternative current resistance (ACR) of the cell and a number of times of charging cycles for which the cell has been charged; and
determining a charging current and a charging voltage of the battery based on the health state of the cell.

17. The non-transitory computer readable storage medium of claim 15, wherein determining the charging strategy for the battery based on the cell characteristic parameters comprises:
determining a cut-off charging voltage of the battery under a constant current charging mode according to a present voltage of the cell, and a present current of the cell and a present temperature of the cell; and
charging the battery based on the charging strategy comprises:
charging the battery at a charging voltage less than the cut-off charging voltage and a constant charging current under the constant current charging mode.

18. The non-transitory computer readable storage medium of claim 15, wherein determining the charging strategy for the battery based on the cell characteristic parameters comprises:
determining a cut-off charging current of the battery under a constant voltage charging mode according to a present voltage of the cell, and a present current of the cell and a present temperature of the cell; and
charging the battery based on the charging strategy comprises:
charging the battery at a charging current greater than the cut-off charging current and a constant charging voltage under the constant voltage charging mode.

19. The non-transitory computer readable storage medium of claim 15, wherein the method further comprises:
detecting a present charging state of the battery during charging of the battery;
when the present charging state of the battery is a float charging state, suspending charging of the battery to release the float charging state; and/or
when the present charging state of the battery is the float charging state, performing control to accelerate discharging the battery to release the float charging state.

20. The non-transitory computer readable storage medium of claim 19, wherein detecting the present charging state of the battery comprises:
obtaining a state of charge (SOC) of the battery; and
when a duration for which the SOC of the battery is greater than a first SOC threshold reaches a preset length of time, determining that the battery is in the float charging state.
